(19) United States
(12) Patent Application Publication
(10) Pub. No.: US 2010/0154228 A1
(43) Pub. Date: Jun. 24, 2010

(54) NON-SPOOLED TRIMMER LINE

(76) Inventors: David L. Watts, Angleton, TX (US); Michael D. Watts, Pearland, TX (US)

Correspondence Address: CG IP LAW, 6002 RUNNING CREEK COURT, KINGWOOD, TX, 77345, US

(21) Appl. No.: 12/643,179

(22) Filed: Dec. 21, 2009

Related U.S. Application Data
(60) Provisional application No. 61/139,561, filed on Dec. 20, 2008.

(51) Int. Cl. A01D 34/416; B23P 11/00

(52) U.S. Cl. 30/347; 29/428

(57) ABSTRACT

The present invention provides a trimmer line for a grass trimmer. The trimmer line is comprised of a cutting string having a cutting end and an engagement end. An engagement device is affixed to the engagement end of the cutting string and has an expanded position and an install position. When the engagement device is in its expanded position, it has a greater outer diameter than in its install position.

This application claims the benefit of U.S. Provisional Application 61/139,561, filed Dec. 20, 2008.

### BACKGROUND OF THE INVENTION

The present invention relates to trimmer line useful in grass trimmers. More specifically, the present invention relates to a non-spooled trimmer line and methods for attaching the non-spooled trimmer line to a grass trimmer.

Grass trimmers typically utilize trimmer line that has been wound around a spool within a trimmer head housing, such as that illustrated in U.S. Pat. No. 5,623,765. The trimmer line is dispensed from the housing through one or more apertures in the housing such that a length of line extends from the housing and is spun by the trimmer at a high speed to cut grass or other vegetation. Through the course of trimming the vegetation, the line wears and shortens and it becomes necessary to dispense additional trimmer line to continue efficient trimming. The mechanisms for dispensing additional trimmer line typically comprise of a spool within the trimmer head housing which must rotate to unwind additional line and must then lock in placed to permit trimming. These mechanisms can be quite complicated due to the requirements of high speed rotation, spooling and dispensing. Accordingly, there is a substantial amount of required maintenance associated with prior art trimmer heads. Additionally, it is inconvenient and can be difficult to replace a coil of trimmer line on a trimmer head mechanism.

Although several attempts have been made to provide a trimmer with a non-spooled trimming string, including U.S. Pat. No. 6,842,984 for a spooless trimmer head to Grant et al, and U.S. Pat. No. 5,887,348 for a cutting head with clamping members to Iacona et al, there remains a need for an improved non-spooled trimmer line.

### SUMMARY OF THE INVENTION

An embodiment of the present invention provides a trimmer line for a grass trimmer. The trimmer line is comprised of a cutting string having a cutting end and an engagement end. An engagement device is affixed to the engagement end of the cutting string and has an expansion section having an expanded position and an install position. When the engagement device is in its expanded position, it has a greater outer diameter than in its install position.

Another embodiment of the present invention provides a trimmer line for insertion through an aperture in a spool hub of a grass trimmer. The trimmer line comprises a cutting string having a cutting end and an engagement end. The trimmer line further comprises an engagement device affixed to the engagement end of the cutting string. The engagement device allows insertion of the cutting string through the aperture in a first direction, but prevents the cutting string from passing back through the aperture in the opposite direction.

Yet another embodiment of the present invention provides a method of affixing a trimmer line to a trimmer head. The trimmer line is comprised of a cutting string having a cutting end and an engagement end with an engagement device attached thereto. The trimmer head has a spool hub with at least one aperture for the receipt of trimmer line therethrough. The method comprises the step of inserting the engagement device through an aperture in the spool hub into the interior of the spool hub, and the step of activating the engagement device of the trimmer line such that passage of the engagement device back through the aperture in the spool hub is resisted.

### BRIEF DESCRIPTION OF THE DRAWINGS

The foregoing and other features and aspects of the present invention will be best understood with reference to the following detailed description of specific embodiments of the present invention, when read in conjunction with the accompanying drawings, wherein:

FIG. 1 is an illustration of a typical prior art trimmer head;

FIG. 2 is an illustration of an embodiment of the trimmer line of the present invention with its engagement device in an install position;

FIG. 3 is an illustration of an embodiment of the trimmer line of the present invention with its engagement device in an expanded position;

FIG. 4 is an illustration of an embodiment of the trimmer line of the present invention inserted into a spool hub with its engagement device in an install position;

FIG. 5 is an illustration of an embodiment of the trimmer line of the present invention inserted into a spool hub with its engagement device in an expanded position;

FIG. 6 is an illustration of an embodiment of the trimmer line of the present invention inserted into a spool hub with its engagement device in an expanded position;

FIG. 7 is an illustration of an embodiment of the trimmer line of the present invention inserted into a spool hub with its engagement device in an install position;

FIG. 8 is an illustration of an embodiment of the trimmer line of the present invention inserted into a spool hub with its engagement device in an expanded position;

FIG. 9 is an illustration of an embodiment of the trimmer line of the present invention inserted into a spool hub with its engagement device in an expanded position;

FIG. 9a is an illustration of an embodiment of a locking mechanism of the present invention.

FIG. 10 is an illustration of an embodiment of the trimmer line of the present invention having a retaining clip as its engagement device;

FIG. 11 is an illustration of an embodiment of the trimmer line of the present invention having its engagement device in an expanded position; and

FIGS. 12a and 12b are alternate embodiments of the engagement device described with reference to FIGS. 4 and 5.

FIGS. 13a-13g provide illustrations of exemplary methods of affixing the engagement device to the cutting string.

### DETAILED DESCRIPTION OF PREFERRED EMBODIMENTS

Refer now to the drawings wherein depicted elements are not necessarily shown to scale and wherein like or similar elements are designated by the same reference numeral through the several views.

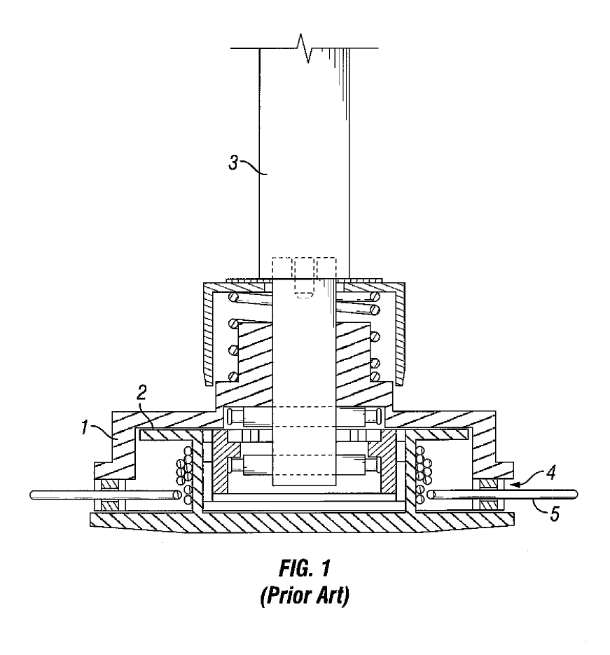

The present invention is directed to a trimmer line adapted for use with a typical grass trimmer head, as is known in the art. For purposes of illustration, and not limitation, FIG. 1 provides an illustration of a prior art standard trimmer head, showing a number of parts, including a spool hub 1, a line spool 2 and a drive shaft 3. The spool hub 1 includes a number of apertures 4 for accommodating the trimmer line 5 as it extends from the line spool 2. The trimmer head is rotationally driven by a motor, not shown, through the drive shaft 3 which spins the trimmer line 5 at a velocity sufficient to cut vegetation, such as grass and weeds.

The embodiments of the present invention described below, will be described with reference to the typical trimmer head depicted in FIG. 1. Although there are many variations in the standard trimmer head such as the mechanism by which additional trimmer line 5 is dispensed when needed and the number of apertures 4 in the spool hub 1 through which the trimmer line is fed, the primary feature of relevance to the present invention is the existence of at least one aperture 4 in the spool hub 1. As the apertures 4 for the trimmer line 5 are necessary in most, if not all, trimmer heads, the present invention is useful in most, if not all, trimmer heads.

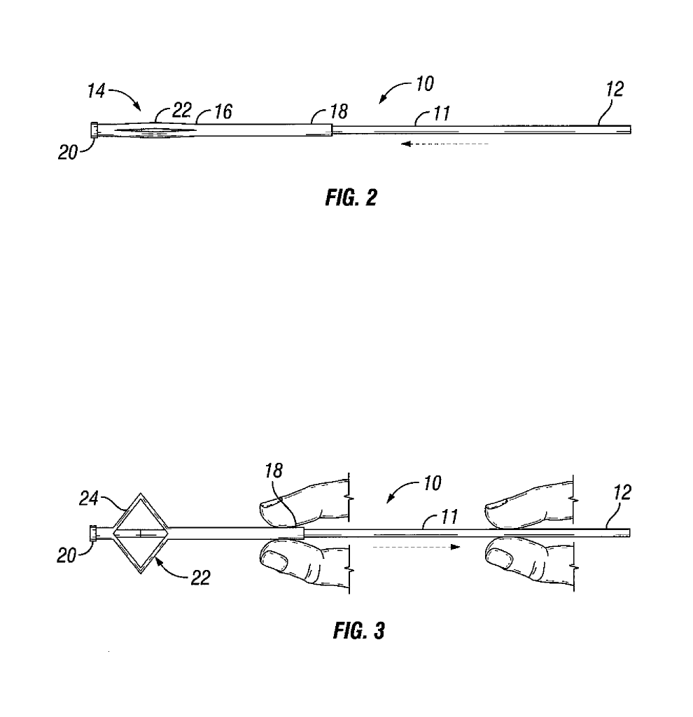

An embodiment of the trimmer line of the present invention is illustrated in FIGS. 2 and 3. As best illustrated in FIG. 2, the trimmer line, referred to generally as numeral 10, comprises a cutting string 11 and an engagement device 16. The cutting string 11 has a cutting end 12 and an engagement end 14. As shown in the illustration, the engagement device 16 is affixed, in a manner that will be described below, to the engagement end 14 of the cutting string 11. The engagement device 16 can be comprised of plastic, nylon, metal, fabric or any combination thereof.

The engagement device 16 has a proximal end 18, a hub end 20, and an expansion section 22. The engagement device 16 has a hollow interior sized for receipt of the cutting string 11 therein. The proximal end 18 of the engagement device 16 is open for receipt of the cutting string 11. In an embodiment of the present invention, the cutting string 11 is inserted through the interior of the engagement device 16 until the engagement end 14 of the cutting string 11 is proximate the hub end 20 of the engagement device 16. It should be noted that the hub end 20 of the engagement device 16 of the present invention can be open, tapered or closed. For example, a closed hub end 20 of the engagement device 16 can be provided such that the cutting string 11 can be inserted through the interior of the engagement device 16 until the engagement end 14 of the cutting string 11 abuts, or nearly abuts, the hub end 20.

To affix the engagement end 14 of the cutting string 11 proximate the hub end 20 of the engagement device 16, techniques such as laser welding, ultrasonic welding, heat welding, heat bonding or crimping can be utilized to advantage. Similarly, adhesives (such as glue or UV glue), mechanical devices such as clamps, small metal staples, nails, stakes or the like can be utilized to advantage and remain within the purview of the present invention.

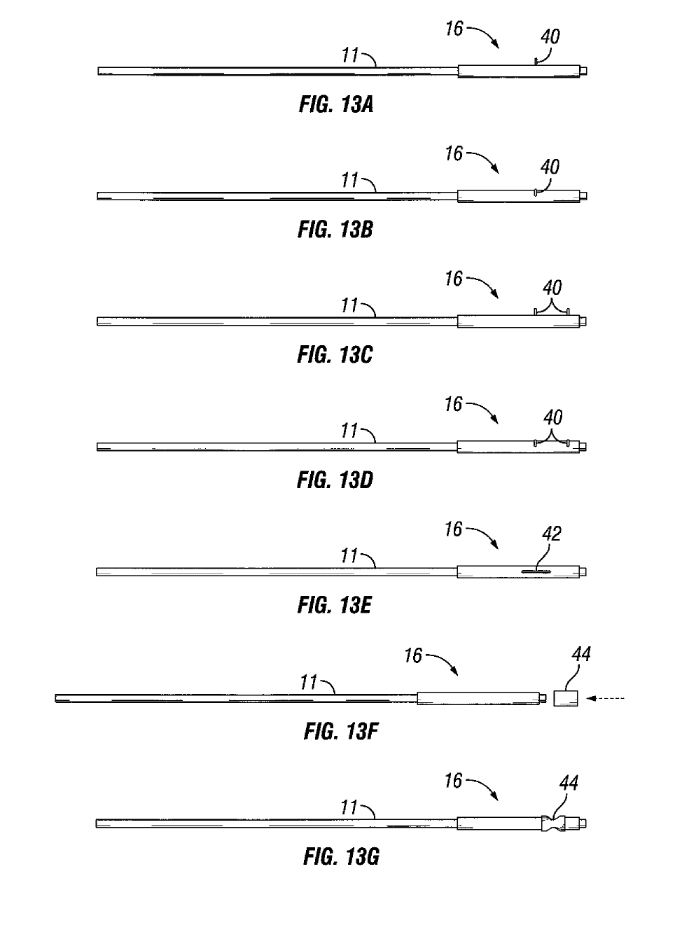

Several examples of affixing the engagement device 16 to the cutting string 11 are provided in FIGS. 13a-13g. As illustrated in the embodiment of FIGS. 13a and 13b, a single wire 40 is inserted through the engagement device 16 and consequentially through the cutting string 11 that has been inserted therein, thus mechanically joining the two elements. Subsequent to mechanically joining the engagement device 16 and the cutting string 11, the portion of the wire 40 that protrudes exterior to the engagement device 16 is either trimmed or bent back (shown) to be substantially flush with the engagement device 16. FIGS. 13c and 13d illustrate an alternate embodiment in which multiple wires 40 are used. Another embodiment of affixing the engagement device 16 to the cutting string 11 is shown in FIG. 13e in which a staple 42 has been used to advantage. Yet another example of affixing the engagement device 16 to the cutting string 11 is shown in FIGS. 13f and 13g. In this embodiment, after inserting the cutting string 11 into the engagement device 16, a compression sleeve 44 is utilized to mechanically bond the engagement device 16 to the cutting string 11.

In the embodiment of the present invention shown in FIGS. 2 and 3, the proximal end 18 of the engagement device 16 is not affixed to the cutting string 11, but rather is in sliding engagement. As shown in FIG. 3, with the engagement end 14 of the cutting string 11 affixed to the hub end 20 of the engagement device 16, pulling on the cutting string 11 in a direction away from the engagement device 16 (as shown by the arrow) while holding the proximal end 18 of the engagement device 16 in place, results in the proximal end 18 of the engagement device 16 sliding along the cutting string 11 towards the hub end 20 of the engagement device 16.

Sliding of the proximal end 18 of the engagement device 16 towards the hub end 20 of the engagement device 16 results in activation of the expansion section 22 from an install position to an expanded position in which the outer diameter of the expansion section 22 is increased. The degree of expansion varies amongst the various embodiments discussed herein, but generally the outer diameter of the expansion section 22 in its expanded position will be greater than the outer diameter of the apertures 4 in the spool hub 1. In the embodiment shown in FIG. 3, the expansion section 22 is comprised of one or more expandable members 24 such as vanes, protrusions, etc. The expandable members 24 may be comprised of materials (e.g. light duty gauge wire) having elastic characteristics such that once expanded, the expandable members 24 maintain their expanded position and in turn maintain the position of the proximal end 18 of the engagement device 16 along the cutting string 11 until the proximal end 18 of the engagement device 16 is forced back toward the cutting end 12 of the cutting string 11.

In an alternate embodiment of the present invention, the frictional resistance to sliding existing between the proximal end 18 of the engagement device 16 and the cutting string 11 is substantial enough to maintain the position of the proximal end 18 of the engagement device 16 along the cutting string 11. In this alternate embodiment, once the proximal end 18 of the engagement device 16 is slid along the cutting string 11 to activate the expansion section 22, the friction between the proximal end 18 of the engagement device 16 and the cutting string 11 maintains the expansion section 22 in an expanded position. This removes the necessity of the expansion section 22 to be comprised of expandable members 24 having suitable elastic characteristics to maintain their expanded position. However, it should be understood that it may be preferable to utilize both elastic expandable members 24 and the friction between the engagement device 16 and the cutting string 11 to maintain the expanded position of the expansion section 22.

It should be noted that the number of expandable members 24 and the geometry and size of the expandable members 24 can vary and remain within the purview of the invention. It is only necessary that the expandable members 24 have the characteristics described above such that they can be used to advantage in the embodiments of the present invention. For example, FIGS. 12a and 12b illustrate an alternate arrangement of expandable members 24.

It should be noted that the cutting string 11 of the present invention can be comprised of nylon, plastic or other materials having characteristics suitable for its intended purpose of cutting vegetation. Additionally, the cross-section of the cutting string 11 can be circular or non-circular. Because the present invention does not utilize a line spool 2 for dispensing the cutting string 11, the difficulties of dispensing a non-circular cutting string 11 are overcome and characteristics of non-circular cross-sections, such as sharper or cleaner vegetation cuts, can be utilized o advantage. It should further be noted that the thickness, or gauge, of the cutting string 11 is only restricted by the size of the apertures 4 in the spool hub 1 and additional and larger apertures 4 may be drilled in the spool hub 1 by the end user.

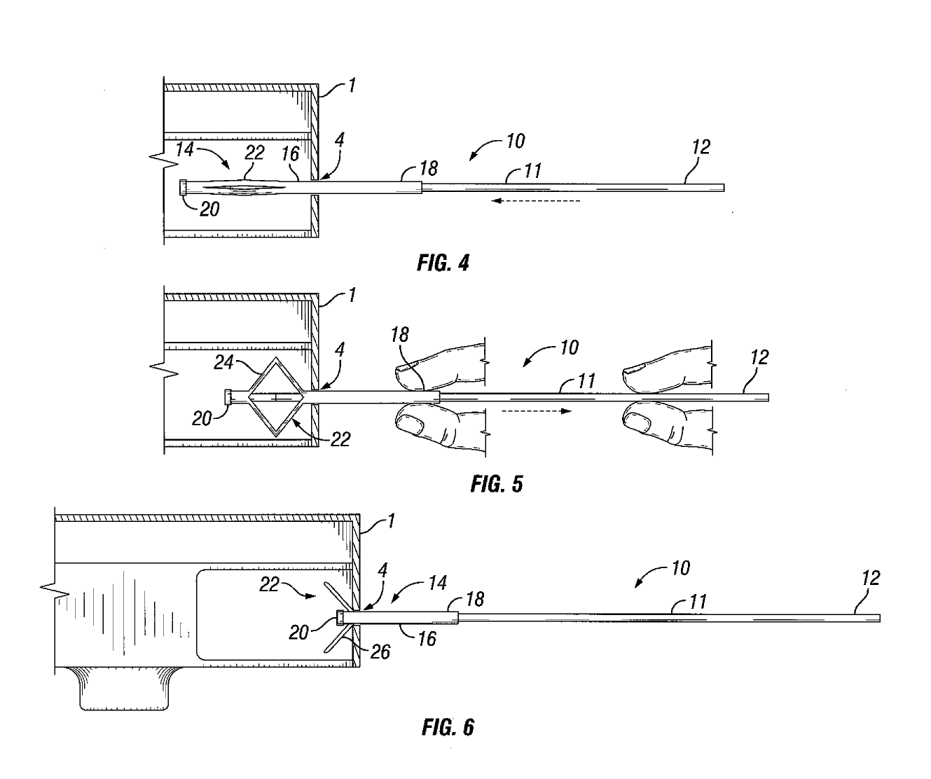

FIGS. 4 and 5 illustrate a method of installing an embodiment of the trimmer line 10 of the present invention within a spool hub 1 having one or more apertures 4. As shown, the trimmer line 10 is comprised of a cutting string 11 having a cutting end 12 and an engagement end 14, and is further comprised of an engagement device 16. The cutting string 11 has been inserted through the engagement device 16 such that the engagement end 14 of the cutting string 11 is proximate the hub end 20 of the engagement device 16. The hub end 20 of the engagement device 16 has been affixed to the engagement end 14 of the cutting string 11 by any of the aforementioned techniques such as by welding, by use of adhesives or by mechanical means such as staples, nails, wires, or compression sleeves. The engagement device in this embodiment is comprised of an expansion section 22 having one or more expandable members 24.

As shown in FIG. 4, the trimmer line 10 has been inserted through an aperture 4 in the spool hub 1 from exterior the spool hub 1. The trimmer line 10 is inserted through the aperture 4 such that the engagement device 16 is located within the interior of the spool hub 1. It should be understood that in its install position, it is not necessary that the engagement device 16 have a smaller outer diameter than the inner diameter of the aperture 4. For instance, the engagement device 16 may be sufficiently flexible to enable insertion through the aperture 4. In this manner, the various embodiments of the present invention can accommodate various sized apertures 4 in the spool hub 1.

As best described with reference to FIG. 5, with the engagement device 16 located within the interior of the spool hub 1, the proximal end 18 of the engagement device 16 is held in position (e.g. by hand) while the cutting string 11 is pulled in a direction (indicated by the arrow) away from the spool hub 1. As the cutting string 11 is pulled, the proximal end 18 of the engagement device 16 slides along the cutting string 11 towards the hub end 20 of the engagement device 16, resulting in activation of the expansion section 22 from its install position to an expanded position in which the outer diameter of the expansion section 22 is greater than the outer diameter of the aperture 4 in the spool hub 1. In its expanded position, the expansion section 22 prevents the trimmer line 10 from passing through the aperture 4 from inside of the spool hub 1, and thus maintains the trimmer line 10 affixed to the spool hub 1. The resistance to passing through the aperture 4 provided by the expansion section 22 is able to maintain the trimmer line 10 affixed to the spool hub 1 even when the trimmer head is in operation (i.e. rotating at speeds sufficient to cut vegetation).

In the embodiment shown in FIGS. 4 and 5, the expansion section 22 is comprised of one or more expandable members 24 comprised of materials having elastic properties such that once expanded, the expandable members 24 maintain their expanded position and in turn maintain the position of the proximal end 18 of the engagement device 16 along the cutting string 11. As discussed above, the proximal end 18 of the engagement device 16 may additionally provide frictional resistance to maintain its position along the cutting string 11.

When the trimmer line 10 of the present invention needs to be replaced because it has been worn or shortened, the proximal end 18 of the engagement device is held in position (e.g. by hand) while the remaining cutting string 11 is pushed in a direction toward the spool hub 1. As the cutting string 11 is pushed, the proximal, end 18 of the engagement device 16 slides along the cutting string 11 towards the cutting end 12 of the cutting string, resulting in de-activation of the expansion section 22 from its expanded position to its install position in which either (a) the outer diameter of the expansion section 22 is less than the inner diameter of the aperture 4 in the spool hub 1, or (b) the expansion section 22 is sufficiently flexible to enable removal through the aperture 4. In its install position, the trimmer line 10 can be removed from the spool hub 1 with minimal resistance provided by the engagement device 16. Once the worn trimmer line 10 has been removed, a new trimmer line 10 can be installed as described above. It should also be noted that in all embodiments, when the cutting string 11 becomes too short to use, the remainder of the string 11 and its engagement device 16 may be pushed inside the spool cavity and another trimmer line 10 may be inserted into the aperture 4. After several lines 10 have been used the spool can be removed and emptied.

It should be noted that in alternate embodiments, rather than holding the proximal end 18 of the engagement device 16 in place while pulling or pushing the cutting string 11 to activate or de-activate the engagement device 16, the same activation/de-activation can be accomplished by holding the cutting string 11 while pushing or pulling the proximal end 18 of the engagement device 16 to slide along the cutting string 11.

FIG. 6 illustrates another embodiment of the trimmer line 10 with an alternate engagement device 16. The engagement end 14 of the cutting string 11 is inserted into the engagement device 16 in a similar manner as previously described embodiments. Likewise, the hub end 20 of the engagement device 16 is affixed to the engagement end 14 of the cutting string in a similar manner as previously described embodiments. In this embodiment, the expansion section 22 of the engagement device 16 is comprised of a gripping mechanism 26.

The gripping mechanism 26 in this embodiment is comprised of a plurality of fingers made from materials having sufficient elasticity (e.g. light gauge wire) that the gripping mechanism 26 remains in an expanded position such that the plurality of fingers are outwardly projecting as shown in FIG. 6. The fingers of the gripping mechanism 26 can be squeezed (e.g. by hand) to an install position in which the diameter is sufficiently reduced for insertion through an aperture 4 in the spool hub 1. Once inserted through the aperture 4, the elastic nature of the fingers of the gripping mechanism 26 results in the gripping mechanism 26 returning to its expanded position in which the gripping mechanism 26 prevents the engagement device 16 (and thus the trimmer line 10) from passing back through the aperture 4 in the spool hub 1. In this manner, the trimmer line 10 remains affixed to the spool hub 1 even when the trimmer head is in operation.

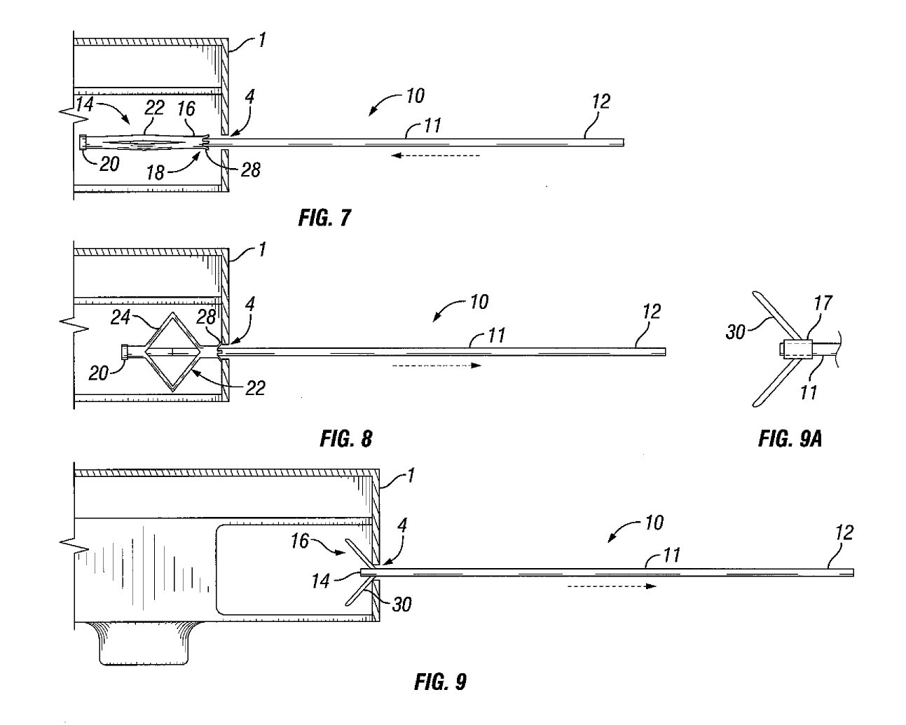

Another embodiment of the trimmer line 10 of the present invention is illustrated in FIGS. 7 and 8. This embodiment is very similar to the embodiment illustrated in FIGS. 2 through 5 but has an alternate engagement device 16. In this embodiment, the proximal end 18 of the engagement device 16 is provided with a plurality of retaining fingers 28. The retaining fingers 28 remain in an expanded position in which the retaining fingers project away from the cutting string 11 and at an angle towards the cutting end 12 of the cutting string. The retaining fingers 28 have sufficient elasticity such that the engagement device 16 can be inserted through an aperture 4 of the spool hub 1 from the outside. Because the retaining fingers 28 are angled toward the cutting end 12 of the cutting string 11, the interaction between the aperture 4 and the retaining fingers 28 forces the retaining fingers 28 inward towards the cutting string 11 and allows for passage through the aperture 4. Once the retaining fingers 28 have passed through the aperture 4, they return to their expanded position.

As best illustrated in FIG. 8, because of the angled configuration of the retaining fingers 28, pulling the cutting string 11 of the trimmer line 10 in a direction away from the spool hub (as indicated by the arrow) while the retaining fingers 28 are located on the interior of the spool hub 1, results in an interference between the retaining fingers 28 and the aperture 4. As the retaining fingers 28 in their expanded position are not able to easily pass back through the aperture 4, the proximal end 18 of the engagement device 16 slides along the cutting string 11 towards the hub end 20 of the engagement device 16, resulting in activation of the expansion section 22 from an install position to an expanded position in which the trimmer line 10 remains affixed to the spool hub 1 even when the trimmer head is in operation.

FIG. 9 provides an illustration of another embodiment of the trimmer line 10 of the present invention. This embodiment is similar to the embodiment described with reference to FIG. 6. However, in this alternate embodiment, the engagement device 16 comprises a plurality of outwardly projecting fingers 30 affixed directly to the engagement end 14 of the cutting string 11 in a manner as previously described such as laser welding. Similar to the embodiment described with reference to FIG. 6, in this embodiment the outwardly projecting fingers 30 can be squeezed to an install position in which the diameter is sufficiently reduced for insertion through an aperture 4 in the spool hub 1. Once inserted through the aperture 4, the retaining fingers 30 return to their expanded position in which the retaining fingers 30 prevent the engagement device 16 from passing back through the aperture 4. In turn, the trimmer line 10 remains affixed to the spool hub 1.

Alternatively, as shown in FIG. 9a, rather than having the outwardly projecting fingers 30 affixed directly to the cutting string 11, this embodiment may further comprise an independent locking mechanism 17 having a hollow receiving end for receipt of the cutting string 11. The outwardly projecting fingers 30 are affixed to the independent locking mechanism 17 which is, in turn, affixed to the cutting string 11 by any of the aforementioned techniques of affixing the engagement device 16 such as laser welding, ultrasonic welding, heat welding, heat bonding, crimping, or through the use of adhesives, mechanical devices, staples, nails or the like. The locking mechanism can be made of plastic, nylon, metal, fabric or any combination thereof.

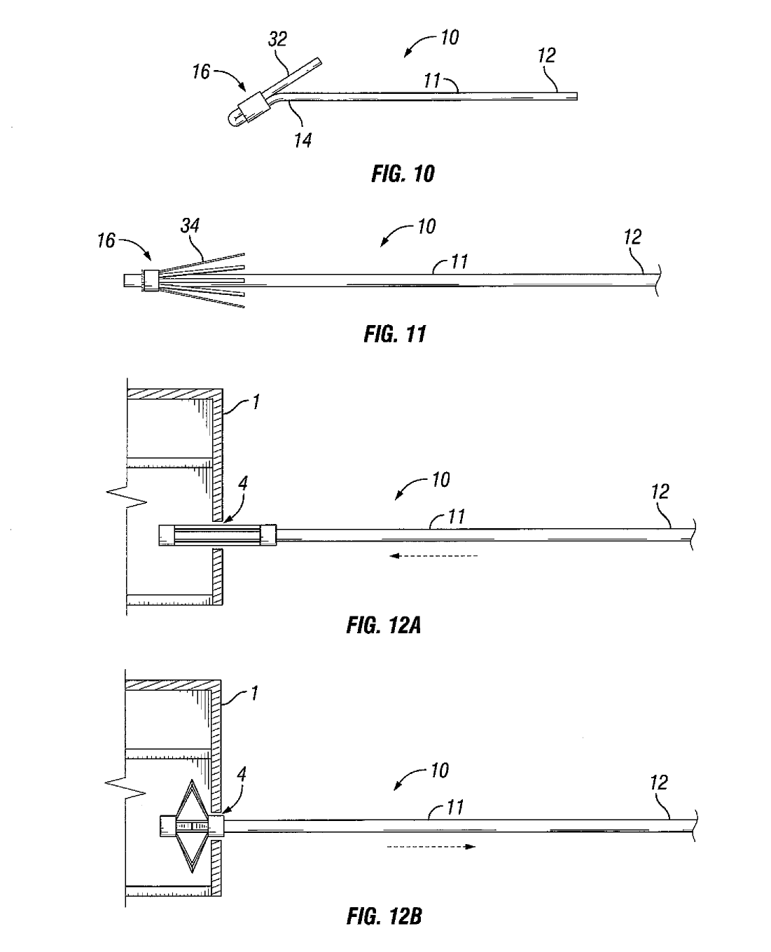

Another embodiment of the present invention is illustrated in FIG. 10. In this embodiment, the engagement device 16 comprises a retaining clip affixed to the engagement end 14 of the cutting string 11. The angled geometry of the retaining member 32 of the clip and the flexibility of the clip is such that it can be inserted through an aperture 4 of the spool hub 1 in a first direction (i.e. from the outside). Upon insertion, the retaining member 32 is forced to flex towards the cutting string 11 to allow passage through the aperture 4. However, once inserted, the angled geometry of the retaining member 32 is such that the retaining member 32 prevents passage of the engagement device 16 back through the aperture 4 in a second direction (i.e. from the inside). In turn, the trimming line 10 is maintained affixed to the spool hub 1.

Another embodiment of the present invention is described with reference to FIG. 11. In this embodiment, the engagement device 16 comprises a plurality of elastic fingers 34 that are angled toward the cutting end 12 of the cutting string 11. The angled geometry and flexibility of the elastic fingers 34 enables the engagement device 16 to be inserted through an aperture 4 in the spool hub 1 in a first direction but prevents passage of the engagement device 16 back through the aperture 4 in a second direction.

It should be understood that although the trimmer line 10 of the present invention has been generally described with reference to installation in apertures 4 provided in standard trimmer heads, such standard trimmer heads can be adapted to accommodate varying sizes and shapes of trimmer line by drilling or otherwise perforating apertures 4 in the hub spool 1. All such modifications of the standard trimmer heads fall within the purview of the invention.

From the foregoing detailed description of specific embodiments of the invention, it should be apparent that a non-spoolable trimmer line 10 has been disclosed. Although specific embodiments of the invention have been disclosed herein in some detail, this has been done solely for the purposes of describing various features and aspects of the invention, and is not intended to be limiting with respect to the scope of the invention. It is contemplated that various substitutions, alterations, combinations and/or modifications, including but not limited to those implementation variations which may have been suggested herein, may be made to the disclosed embodiments without departing from the spirit and scope of the invention as defined by the appended claims which follow.

What is claimed is:

1. A trimmer line for a grass trimmer, comprising:
a. a cutting string having a cutting end and an engagement end;
b. an engagement device affixed to the engagement end of the cutting string, the engagement device comprises an expansion section having an expanded position and an install position; and
c. wherein the expansion section has a greater outer diameter in its expanded position.

2. The trimmer line of claim 1, wherein the engagement device comprises a hollow sleeve.

3. The trimmer line of claim 2, wherein the engagement device is affixed to the cutting string by wire, staples, nails or stakes.

4. The trimmer line of claim 2, wherein the engagement device is affixed to the cutting string by clamping or crimping.

5. The trimmer line of claim 2, wherein the engagement device is affixed to the cutting string by welding, bonding or adhesives.

6. The trimmer line of claim 1, wherein the expansion section comprises one or more expandable members.

7. The trimmer line of claim 6, wherein the one or more expandable members are maintained in an expanded state when the expansion section is in its expanded position.

8. The timmer line of claim 1, wherein the expansion section comprises a plurality of outwardly projecting fingers having sufficient elasticity to remain in an expanded position.

9. The trimmer line of claim 8, wherein the plurality of outwardly projecting fingers are affixed directly to the cutting line.

10. The trimmer line of claim 1, wherein the engagement device comprises a plurality of retaining fingers that permit insertion through an aperture but provide resistance to removal back through the aperture.

11. The trimmer line of claim 10, wherein the resistance to removal back through the aperture provided by the retaining fingers activates the expansion section.

12. A trimmer line for insertion through an aperture in a spool hub of a grass trimmer, comprising:
a. a cutting string having a cutting end and an engagement end;
b. an engagement device affixed to the engagement end of the cutting string, and
c. wherein the engagement device allows insertion of the cutting string through the aperture in a first direction, but prevents the cutting string from passing back through the aperture in the opposite direction.

13. The trimmer line of claim 12, wherein the engagement device comprises a retaining clip having an angled geometry and flexibility to enable insertion of the cutting string through the aperture in a first direction but prevent the cutting string to pass back through the aperture in the opposite direction.

14. The trimmer line of claim 12, wherein the engagement device comprises a plurality of elastic fingers angled away from the aperture.

15. A method of affixing a trimmer line to a trimmer head, the trimmer line comprised of a cutting string having a cutting end and an engagement end with an engagement device attached thereto, the trimmer head having a spool hub with at least one aperture for the receipt of trimmer line therethrough, the method comprising:
a. inserting the engagement device through an aperture in the spool hub into the interior of the spool hub; and
b. activating the engagement device of the trimmer line such that passage of the engagement device back through the aperture in the spool hub is resisted.

16. The method of claim 15 in which the engagement device is activated by pulling the cutting string in a direction away from the aperture.
